(19) United States
(12) Patent Application Publication
(10) Pub. No.: US 2005/0281928 A1
(43) Pub. Date: Dec. 22, 2005

(54) Insulative, pliable frozen treat receptacle and method

(76) Inventor: Loretta J. Crowley, Stow, MA (US)

Correspondence Address: THOMAS P O'CONNELL, 135 CAMBRIDGE STREET SUITE 10, BURLINGTON, MA, 01803, US

(21) Appl. No.: 10/869,332

(22) Filed: Jun. 16, 2004

(51) Int. Cl. A23G 1/00

(52) U.S. Cl. 426/393

(57) ABSTRACT

A frozen treat receptacle and a method for retaining a frozen confection employing the same. The frozen treat receptacle has a first wall panel coupled to a second wall panel to define a pocket with an open inner volume and an open mouth. The panels can be coupled by a unitary formation of the wall panels, by adhesive, by heat sealing, by sewing, or by any other effective arrangement. The wall panels can be formed from an insulative material, such as resiliently compressible closed cell foam material. The wall panels can be rectangular and substantially similar in size and shape and can have widths of approximately 2 and ½ inches, lengths of approximately 4 and ¾ inches, and thicknesses of approximately 2 mm. The frozen treat receptacle can be capable of being removably and replaceably coupled to an external structure, such as by hook and loop material.

### FIELD OF THE INVENTION

The present invention relates generally to specialized receptacles. More particularly, the present patent discloses and protects an insulative and pliable receptacle for frozen treats, including frozen liquid confections retained in oblong, bar shaped packaging and other frozen treats, and a method for employing the same.

### BACKGROUND OF THE INVENTION

It will be appreciated, of course, that the prior art has disclosed innumerable receptacles. Indeed, the cumulative prior art teaches receptacles that could be employed for retaining substantially any material or structure. Nonetheless, as the present inventor has come to appreciate, there remains a gap in the present field of endeavor for which a remedy would represent a useful advance in the art.

Caregivers for children will be well aware that the thermoreceptors of children are extremely sensitive such that their haptic perception of hot and cold is exaggerated as compared to adults. It will be further appreciated that many adults have similarly high sensitivities to hot and cold. While substantially any person will find touching extremely hot and extremely cold articles and substances uncomfortable over time, the aforementioned children and sensitive adults are often unable to tolerate continued, direct contact with articles and materials in such temperature conditions.

For example, one prominent situation in which a child's haptic sensitivity to cold is quite pronounced is where he or she seeks to hold and enjoy a frozen confection. Frozen confections can, of course, come in a variety of types. Two frozen confections are known to substantially all. One commonly enjoyed frozen confection, often generically referred to by its registered trademark Popsicle, simply comprises a flavored, frozen liquid retained on a wooden stick. Another popular frozen confection is again founded on a flavored, frozen liquid, but that frozen material is simply encased in an oblong plastic sleeve. While many sources produce and sell such frozen confections, many are sold under the registered trademarks ICE POPS, POP-ICE, and FLAVOR ICE, all owned by the Jel Sert Company of Chicago, Ill.

Taking the sleeved frozen confection as an example, a child seeking to consume such a frozen article normally must hold the article in his or her hand by the sleeved portion with a portion of the frozen liquid projecting from an open end of the sleeve. With the frozen confection so retained, only a thin film of plastic is disposed between the child's sensitive hand and what is essentially ice. As such, some children typically find holding such sleeved frozen confections notably uncomfortable and objectionable. In addition, melted confectionary material tends to drip and dribble from the protruding portion of the frozen confection thereby making the holder's hands and clothes and, quite often, the holder's surroundings messy and sticky. Such adverse results are at least as common with frozen confections retained on wooden sticks.

With these problems all too prevalent, a number of makeshift solutions have been attempted. One common attempt has come in the form of inserting the plastic sleeve with the frozen confection disposed therein into a sock. With this, the fabric of the sock will be interposed between the child's hand and the frozen confection. As a result, the sock can act as an insulative barrier to limit the sensation deriving from the cold of the frozen confection. However, such a practice of using a sock to hold a food treat could be considered less than appetizing or sanitary to many. Furthermore, dripping confectionary material tends to saturate the sock causing it to be a source of stickiness, mess, and discomfort. Once so saturated, the sock must be entirely and thoroughly washed and dried before reuse. Even further, many types of socks would be unlikely to provide substantial insulation such that, at best, they only partially address the issues at hand.

In light of the foregoing, it will be appreciated that there is a need for a method and device for retaining frozen confections that addresses the outstanding needs and deficiencies of the prior art. More particularly, it is clear that there is a need for a frozen confection retaining device and method that enables a person to hold a frozen confection comfortably and stably with a minimum of mess and stickiness.

### BRIEF DESCRIPTION OF THE DRAWINGS

In the accompanying drawings:

FIG. 1 is a perspective view of an insulative, pliable frozen treat receptacle according to the present invention;

FIG. 2 is a view in front elevation of the insulative, pliable frozen treat receptacle of FIG. 1;

FIG. 3 is a view in rear elevation of the insulative, pliable frozen treat receptacle of FIG. 1;

FIG. 4 is a view in side elevation of the insulative, pliable frozen treat receptacle of FIG. 1 with the opposite side being identical thereto;

FIG. 5 is a top plan view of the insulative, pliable frozen treat receptacle of FIG. 1;

FIG. 6 is a view in front elevation of an alternative embodiment of an insulative, pliable frozen treat receptacle according to the invention disclosed herein;

FIG. 7 is a view in front elevation of another alternative embodiment of an insulative, pliable frozen treat receptacle pursuant to the current invention;

FIG. 8 is a perspective view of yet another embodiment of the present invention for an insulative, pliable frozen treat receptacle; and

FIG. 9 is a perspective view of a further embodiment of the insulative, pliable frozen treat receptacle.

### SUMMARY OF THE INVENTION

Advantageously, the present invention is founded on the broadly stated object of providing a receptacle for frozen treats and a method for using the same that meets the needs and deficiencies that the prior art has left unmet.

A more particular object of the invention is to provide a frozen treat receptacle and method that enables even those with high haptic sensitivity to cold to hold a frozen confection in a stable and comfortable manner.

A further object of embodiments of the invention is to provide a frozen treat receptacle and method that enables a person to hold and enjoy a frozen confection with reduced stickiness and mess as compared to the methods and devices of the prior art.

Another object of particular embodiments of the invention is to provide a frozen treat receptacle and method that can be readily cleaned and reused.

An even further object of embodiments of the invention is to provide a frozen treat receptacle and method that is particularly sized, shaped, and otherwise configured for retaining frozen confections.

Still another object of embodiments of the present invention is to provide a frozen treat receptacle and method that enables a user to advance a retained frozen treat progressively for enabling consumption of the same.

Yet another object of the invention is to provide a frozen treat receptacle and method that is effective in function while remaining simple and inexpensive in manufacture and use.

These and further objects and advantages of the present invention will become obvious not only to one who reviews the present specification and drawings but also to one who has an opportunity to make use of an embodiment of the present invention for a frozen treat receptacle and method. However, it will be appreciated that, although the accomplishment of each of the foregoing objects in a single embodiment of the invention may be possible and indeed preferred, not all embodiments will seek or need to accomplish each and every potential advantage. Nonetheless, all such embodiments should be considered within the scope of the present invention.

In carrying forth the aforementioned objects, a frozen treat receptacle according to the present invention can have a first wall panel and a second wall panel coupled to the first wall panel to define a pocket for receiving at least a portion of a frozen confection. The first and second wall panels can each be formed from an insulative material. The insulative material can comprise a pliable, resiliently compressible material, such as resiliently compressible closed cell foam material.

The first and second wall panels can each have a first end edge, a second end edge opposite and generally parallel to the first end edge, a first side edge, and a second side edge opposite and generally parallel to the first side edge. The second end edges of the first and second wall panels can be joined to form a second end of the frozen treat receptacle. Also, the first and second side edges of the wall panels can be joined to form first and second sides of the frozen treat receptacle. With this, an open mouth will be defined by the first end edges of the first and second wall panels, and an open inner volume will be disposed between the first and second wall panels. With this, at least a portion of a frozen confection can be received through the open mouth and into the open inner volume for being retained therein.

The second end edges and the first and second side edges of the first and second wall panels can be joined over substantially entire lengths thereof, possibly by a means for creating a substantially liquid light seal therebetween. The joining of the edges can be accomplished in a variety of ways, such as by adhesive interposed between the edges, by heat sealing of the edges, or by sewn stitches in the side edges. Furthermore, the edges can be joined by a unitary formation of the first and second wall panels. Under such an arrangement, the first side, the second side, and the second end of the frozen treat receptacle will be devoid of seams. Further still, the first and second wall panels can be formed from a generally rectangular single panel of material folded substantially evenly such that a fold will form the first side of the frozen treat receptacle, the second end of the frozen treat receptacle will be formed by opposed edges of the single panel that project away from the fold, and the second side of the frozen treat receptacle will be formed by opposed edges of the single panel generally parallel to the fold.

In any case, the first and second wall panels can be generally rectangular and substantially similar in size and shape. While it will be expressly noted that the dimensions of the frozen treat receptacle can vary widely within the scope of the invention, embodiments of the receptacle could have first and second wall panels each with a width of between approximately 2 and approximately 3 inches and a length between approximately 4 and approximately 6 inches. One exemplary embodiment of the frozen treat receptacle could have first and second wall panels that are approximately 2 and ½ inches wide and approximately 4 and ¾ inches long. When so constructed, the frozen treat receptacle can be considered to be ideally suited for receiving and retaining at least a base portion of a typical frozen confection. The wall panels can have any suitable thickness. In one embodiment, the wall panels can be approximately 2 mm thick while other embodiments can be slightly thicker.

Where a user might seek to retain the frozen treat receptacle relative to an external structure, such as a cooler, a freezer, an article of clothing, or any other structure, the frozen treat receptacle can additionally include a means for removably and replaceably coupling the frozen treat receptacle to an external structure. A variety of means are possible and within the scope of the present invention. In one construction, the means can comprise a portion of hook material in combination with a portion of loop material with one of the two disposed on the frozen treat receptacle and with the other of the two disposed on the external structure. In another construction, a snap coupling can be provided between the frozen treat receptacle and the external structure.

In one practice of the invention, a frozen treat receptacle can be used in a method for retaining a frozen confection with the method being founded on the steps of providing a frozen treat receptacle as broadly described herein; providing a frozen confection of the type comprising an elongate bar of frozen liquid that retained within an elongate, generally rectangular sleeve; and inserting at least a portion of the frozen confection through the open mouth of the pocket and into the open inner volume thereof. With this, the frozen confection can be retained with the frozen treat receptacle interposed between the frozen confection and a hand of a user.

With the frozen confection so disposed, a user can retain, manipulate, and consume the elongate bar of confectionary material without a need for directly touching the elongate bar or the sleeve in which it is retained. The user can thus enjoy the frozen confection while having his or her hands insulated from the cold of the elongate bar due to the insulative effects of the first and second wall panels. Furthermore, where the first and second wall panels are formed from a flexible material, the user can systematically advance elongate bar longitudinally relative to the frozen treat receptacle and, possibly, relative to the rectangular sleeve by a manipulation of the first and second wall panels of the frozen treat receptacle. Any effective manipulation of the first and second wall panels can be employed, including squeezing, pinching, pressing, squishing, bending, sucking, and/or otherwise manipulating the first wall panel and/or the second wall panel to induce relative movement of the elongate bar. In one example, the user could progressively squeeze the first and second wall panels together starting adjacent to the second end edges thereof to cause the elongate bar to be progressively extended from within the open inner volume of the frozen treat receptacle and, possibly, from within the rectangular sleeve to enable an enjoyable and comfortable consumption of the frozen confection.

One will appreciate that the foregoing discussion broadly outlines the more important features of the invention to enable a better understanding of the detailed description that follows and to instill a better appreciation of the inventor's contribution to the art. Before any particular embodiment or aspect thereof is explained in detail, it must be made clear that the following details of construction, descriptions of hardware and, software designs, and illustrations of inventive concepts are mere examples of the many possible manifestations of the invention.

### DETAILED DESCRIPTION OF PREFERRED EMBODIMENTS

As is the case with many inventions, the present invention for an insulative, pliable receptacle for frozen treats is subject to a wide variety of embodiments. However, to ensure that one skilled in the art will fully understand and, in appropriate cases, be able to practice the present invention, certain preferred embodiments of the broader invention revealed herein are described below and shown in the accompanying drawings.

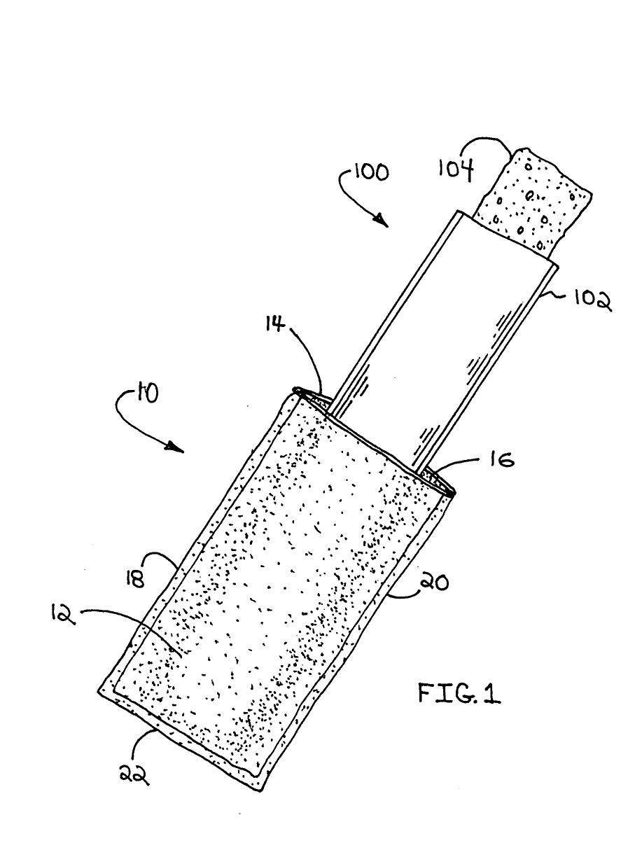

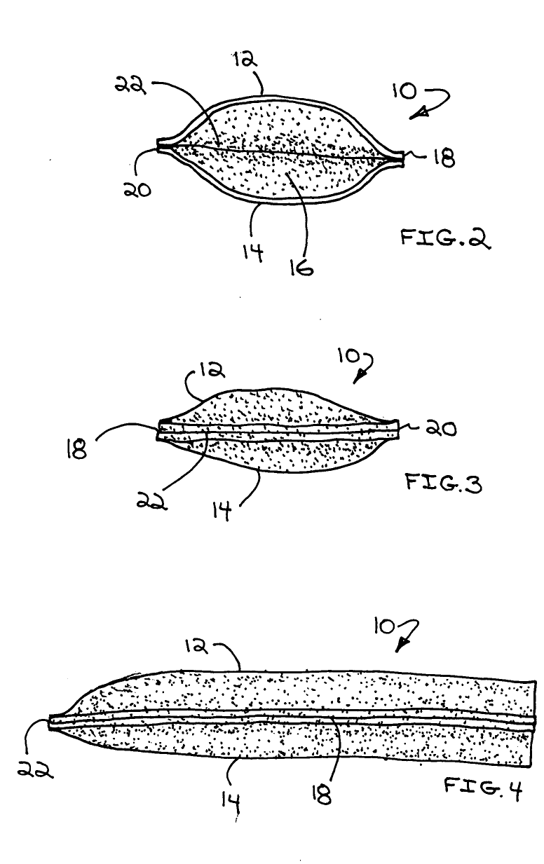

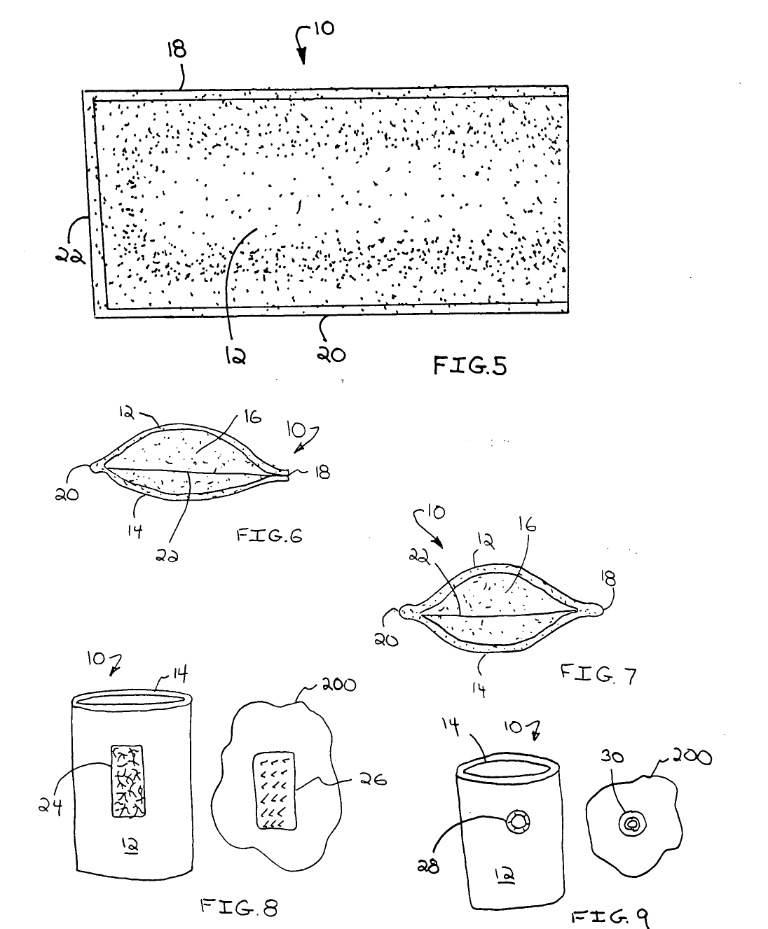

With this in mind and looking more particularly to the accompanying drawing figures, a first preferred embodiment of an insulative and pliable receptacle for frozen treats is indicated generally at 10 in FIGS. 1 through 5. There, one sees that the insulative, pliable receptacle for frozen treats 10 in this embodiment has a first wall panel 12 coupled to a second wall panel 14. The first wall panel 12 has peripheral edges comprising a first end edge, a second end edge opposite and generally parallel to the first end edge, a first side edge, and a second side edge opposite and generally parallel to the first side edge. Similarly, the second wall panel 14 has peripheral edges comprising a first end edge, a second end edge opposite and generally parallel to the first end edge, a first side edge, and a second side edge opposite and generally parallel to the first side edge.

In this exemplary embodiment, the first and second wall panels 12 and 14 are substantially similar in size and shape. The second end edge of the first wall panel 12 is joined to the second end edge of the second wall panel 14. Also, the first side edge of the first wall panel 12 is joined to the first side edge of the second wall panel 14, and the second side edge of the first wall panel 12 is joined to the second side edge of the second wall panel 14. The first end edges, the first side edges, and the second side edges of the first and second wall panels 12 and 14 can be joined in any appropriate manner and by any effective means. As will be described more fully below, the first and second wall panels 12 and 14 can be formed from a flexible, insulative material.

With the second end edges, the first side edges, and the second side edges so joined, the frozen treat receptacle 10 is left with an open mouth 16 between the first end edges of the first and second wall panels 12 and 14 that leads to an open inner volume between the first and second wall panels 12 and 14. With this, as is depicted in FIG. 1, an oblong, sleeved frozen confection 100 can have a base portion thereof slid through the open mouth 16 and into the open inner volume of the frozen treat receptacle 10. The frozen confection 100 in this example comprises an elongate bar 104 of frozen, flavored liquid that is retained within an elongate, generally rectangular sleeve 102.

With the frozen confection 100 so disposed, a user can retain, manipulate, and consume the elongate bar 104 of confectionary material without a need for directly touching the elongate bar 104 or the sleeve 102 in which it is retained. As a result, the user can enjoy the frozen confection 100 while having his or her hands insulated from the cold of the elongate bar 104 due to the insulative effects of the first and second wall panels 12 and 14. Furthermore, where the first and second wall panels 12 and 14 are formed from a flexible material, the user can advance elongate bar 104 longitudinally relative to the frozen treat receptacle 10 and, possibly, relative to the rectangular sleeve 102 by a manipulation of the first and second wall panels 12 and 14 of the frozen treat receptacle 10, such as by squeezing, pinching, pressing, squishing, bending, sucking, and/or otherwise manipulating the first wall panel 12 and/or the second wall panel 15 to induce relative movement of the elongate bar 104. For example, the user could progressively squeeze the first and second wall panels 12 and 14 together starting adjacent to the second end edges thereof to cause the elongate bar 104 to be progressively extended from within the open inner volume of the frozen treat receptacle 10 and, possibly, from within the rectangular sleeve 102 to enable an enjoyable and comfortable consumption of the frozen confection 100.

The second end edges and the first and second side edges of the first and second wall panels 12 and 14 can be coupled in any appropriate manner. The second end edges and the first and second side edges preferably will be sealed together over substantially the entire lengths thereof whereby the open inner volume will comprise an essentially sealed, ideally fluid-tight, pocket with a sealed second end 22, sealed first and second sides 18 and 20, and an open first end defining the open mouth 16. In certain embodiments, such as in the embodiment depicted in FIGS. 1 through 5, the first and second wall panels 12 and 14 could be coupled by a heat sealing of the second end edges and the first and second side edges. Alternatively or additionally, the edges can be joined by an adhesive interposed between the first and second wall panels 12 and 14 adjacent to the edges thereof. Even further, the first and second wall panels 12 and 14 can be additionally or alternatively coupled together by a sewing of the second edges and the first and second side edges together.

Still further, as in the example of FIG. 6, the frozen treat receptacle 10 can be formed by a single, generally rectangular panel of material evenly folded to form the first and second wall panels 12 and 14 such that a fold will form the first or the second side 18 or 20, the second end 22 will be formed by any effective coupling of the opposed edges of the single panel projecting away from the fold, and the second or first side 20 or 18 will be formed by any effective coupling of the opposed edges of the single panel generally parallel to the fold.

Even further, as is shown in FIG. 7, alternative embodiments of the frozen treat receptacle 10 could be crafted wherein the first and second wall panels 12 and 14 are formed unitarily, such as by molding or any other appropriate method. Under such an arrangement, the frozen treat receptacle 10 will comprise a single piece of material. With a unitary molding, there will be no seams between the first and second wall panels 12 and 14 thereby further ensuring the durability and flexibility of the frozen treat receptacle 10 and its comfort during use. Still other configurations and methods for forming the frozen treat receptacle 10 may occur to one skilled in the art after reading this disclosure. All such configurations and methods should be considered to be within the scope of the present invention.

Yet another possible construction of the frozen treat receptacle 10 is shown in FIG. 8. There, the frozen treat receptacle 10 again has first and second wall panels 12 and 14 formed unitarily. However, the frozen treat receptacle 10 of FIG. 8 further provides a means for accommodating situations where a consumer may want to store the frozen treat receptacle 10, possibly with a frozen confection 100 retained therein, relative to an external structure 200. Of course, the type of external structure 200 can vary infinitely. By way of example, a consumer might seek to retain one or more frozen treat receptacles 10 relative to an inside or outside surface of a cooler, relative to an article of clothing, or relative to an inner wall of a freezer.

To facilitate this, the embodiment of the frozen treat receptacle 10 of FIG. 8 further incorporates means for removably and replaceably coupling the frozen treat receptacle 10 relative to an external structure 200. Of course, numerous such means would be readily obvious to one of skill in the art after reading this disclosure. In this embodiment, the removable and replaceable coupling is enabled by a strip 24 of loop material disposed on the first wall panel 12 of the frozen treat receptacle 10 in combination with a strip 26 of hook material disposed on the external structure 200. One will appreciate that the relative disposition of the strips 22 and 24 of hook and loop material is of little consequence such that the two could quite obviously be reversed.

In FIG. 9, the means for removably and replaceably coupling the frozen treat receptacle 10 to an external structure 200 takes the form of a snap coupling produced by a male snap member 30 and a female snap member 28. In this example, the male snap member 30 is disposed on the external structure 200 while the female snap member 28 is disposed on the frozen treat receptacle. Of course, the two could be reversed in disposition with substantially no effect.

Of course, the dimensions of the first and second wall panels 12 and 14 and the frozen treat receptacle 10 in general can vary within the scope of the present invention. The first and second wall panels 12 and 14 can be substantially identical in size and shape. In certain embodiments, each can have a width between first and second side edges of, by way of example, between approximately 2 and approximately 3 inches and preferably approximately 2 and ½ inches. The first and second wall panels 12 and 14 can, by way of example, have a length between first and second end edges of between approximately 4 and approximately 6 inches and preferably approximately 4 and ¾ inches.

When so constructed, the frozen treat receptacle 10 is ideally suited for receiving and retaining a typical frozen confection 100. More particularly, the aforementioned dimensions have been found to be particularly advantageous for retaining typical sleeved frozen confections 100 in a snug manner while allowing them to be inserted and removed relative to the open inner volume of the frozen treat receptacle 10 easily and conveniently. Furthermore, while a base portion of the sleeved frozen confection 100 will be snugly retained within the open inner volume of the frozen treat receptacle 10 thereby to achieve the benefits described herein, a substantial portion of the frozen confection 100 will project from the frozen treat receptacle 10 thereby to enable a convenient consumption of the same.

Under one construction of the invention, the first and second wall panels 12 and 14 can be formed from a resiliently compressible, insulative material. For example, the first and second wall panels 12 and 14 can be crafted from foam material, such as foamed rubber. In one example, the foam material can be a closed cell, possibly polyethylene, foam. Closed cell foam can be considered advantageous for its soft and smooth topological properties and for its resilient shape memory, its waterproof nature, and its lack of liquid absorption. Also, while the frozen treat receptacle 10 is, of course, not intended to be eaten, the foam will preferably be non-toxic in nature, particularly since the frozen treat receptacle 10 will often be used by children. In any case the foam material can have substantially any appropriate thickness. In one exemplary embodiment, the first and second wall panels 12 and 14 can have a thickness of approximately 2 mm while other embodiments can be slightly thicker.

When the first and second wall panels 12 and 14 are formed form a resiliently compressible foam material, the flexibility, compressibility, pliability, and resiliency of the resulting frozen treat receptacle 10 provide a plurality of advantages even beyond those mentioned previously. For example, the frozen treat receptacle 10 can be disposed in a flat configuration upon manufacture, during shipping, between and after uses, and at other times as necessary or desirable. However, the frozen treat receptacle 10 can be readily reconfigured to what can be termed an open configuration depicted, for example, in FIGS. 1 through 5, for enabling a receipt and retention of the frozen confection 100 within the open inner volume through the open mouth 16. Such an open configuration could be achieved simply by slipping the frozen confection 100 between the first and second wall panels 12 and 14. If necessary, however, one could press the first and second sides 18 and 20 together to induce an opening of the mouth 16. Furthermore, the light weight of the foam material employed in constructing the frozen treat receptacle 10 will limit shipping costs and ease overall handling.

With the frozen confection 100 so received and retained, the first and second wall panels 12 and 14 can act as a thermally insulative barrier between the cold surface presented by the frozen confection 100 and the user's hands. Of course, the frozen treat receptacle 10 will additionally provide insulation to the frozen elongate bar 104 thereby tending to help the frozen elongate bar 104 remain frozen while also tending to maintain any portions of the frozen elongate bar 104 that do melt in a cold and enjoyable temperature condition. Furthermore, in its position surrounding a base portion of the frozen elongate bar 104, the frozen treat receptacle 10 will tend to catch or otherwise receive any liquid that may drip from the frozen elongate bar 104 thereby to reduce the mess and stickiness that have been inherent under prior art methods. Even further, a frozen treat receptacle 10 formed from insulative foam will present a surface that is smooth and soft and perceived as being warm to the touch. Also, a user can readily clean the frozen treat receptacle 10 for sanitary reuse simply by hand rinsing it or by tossing it in a dishwasher.

Advantageously, the resiliently compressible foam material produces a frozen treat receptacle 10 that is durable such that it can be used numerous times if desired. However, the frozen treat receptacle 10 can also be constructed relatively inexpensively such that one could reasonably dispose of the frozen treat receptacle 10 after one or just a few uses without substantial economic waste. Indeed, one could foresee a person purchasing multiple frozen treat receptacles 10 for disposable or semi-disposable usage. One could further contemplate a manufacturer of frozen confections 100 enclosing one or more frozen treat receptacles 10 with each package of frozen confections 100 sold. In any case, the first and second wall panels 12 and 14 could be further employed to display images including ornamental, advertising, and other images.

From the foregoing, it will be clear that the present invention has been shown and described with reference to certain preferred embodiments that merely exemplify the broader invention revealed herein. Certainly those skilled in the art can conceive of alternative embodiments. For instance, those with the major features of the invention in mind could craft embodiments that incorporate those major features while not incorporating all of the features included in the preferred embodiments.

With the foregoing in mind, the following claims are intended to define the scope of protection to be afforded the inventor, and the claims shall be deemed to include equivalent constructions insofar as they do not depart from the spirit and scope of the present invention. A plurality of the following claims may express certain elements as a means for performing a specific function, at times without the recital of structure or material. As the law demands, these claims shall be construed to cover not only the corresponding structure and material expressly described in this specification but also equivalents thereof.

1. A frozen treat receptacle for enabling a person to retain a frozen confection, the frozen treat receptacle comprising:
a first wall panel; and
a second wall panel coupled to the first wall panel;
wherein the first wall panel is coupled to the second wall panel to define a pocket for receiving at least a portion of a frozen confection; and
wherein the first wall panel and the second wall panel are formed from insulative material.

2. The frozen treat receptacle of claim 1 wherein the first wall panel has a first end edge, a second end edge opposite and generally parallel to the first end edge, a first side edge, and a second side edge opposite and generally parallel to the first side edge; wherein the second wall panel has a first end edge, a second end edge opposite and generally parallel to the first end edge, a first side edge, and a second side edge opposite and generally parallel to the first side edge; and wherein the second end edge of the first wall panel is joined to the second end edge of the second wall panel to form a second end of the frozen treat receptacle, the first side edge of the first wall panel is joined to the first side edge of the second wall panel to form a first side of the frozen treat receptacle, and the second side edge of the first wall panel is joined to the second side edge of the second wall panel to form a second side of the frozen treat receptacle thereby to leave an open mouth defined by the first end edges of the first and second wall panels and an open inner volume between the first and second wall panels whereby at least a portion of a frozen confection can be received through the open mouth and into the open inner volume for being retained therein.

3. The frozen treat receptacle of claim 2 wherein the second end edges, the first side edges, and the second side edges of the first and second wall panels are joined over substantially entire lengths thereof.

4. The frozen treat receptacle of claim 3 wherein second end edges, the first side edges, and the second side edges of the first and second wall panels are joined by a means for creating a substantially liquid tight seal therebetween.

5. The frozen treat receptacle of claim 3 wherein the second end edges, the first side edges, and the second side edges of the first and second wall panels are joined by adhesive interposed therebetween.

6. The frozen treat receptacle of claim 3 wherein the second end edges, the first side edges, and the second side edges of the first and second wall panels are joined by heat sealing.

7. The frozen treat receptacle of claim 3 wherein the second end edges, the first side edges, and the second side edges of the first and second wall panels are joined by sewn stitches.

8. The frozen treat receptacle of claim 3 wherein the second end edges, the first side edges, and the second side edges of the first and second wall panels are joined by a unitary formation of the first and second wall panels whereby the second end, the first side, and the second side of the frozen treat receptacle are devoid of seams.

9. The frozen treat receptacle of claim 3 wherein the first and second wall panels are formed from a generally rectangular single panel of material folded substantially evenly whereby a fold forms the first side of the frozen treat receptacle, the second end of the frozen treat receptacle is formed by opposed edges of the single panel that project away from the fold, and the second side of the frozen treat receptacle is formed by opposed edges of the single panel generally parallel to the fold.

10. The frozen treat receptacle of claim 1 wherein the first and second wall panels are generally rectangular and substantially similar in size and shape.

11. The frozen treat receptacle of claim 10 wherein the first and second wall panels each has a width between first and second side edges of between approximately 2 and approximately 3 inches and a length between first and second end edges of between approximately 4 and approximately 6 inches.

12. The frozen treat receptacle of claim 11 wherein the first and second wall panels each has a width between first and second side edges of approximately 2 and ½ inches and a length between first and second end edges of approximately 4 and ¾ inches whereby the frozen treat receptacle is ideally suited for receiving and retaining at least a base portion of a frozen confection.

13. The frozen treat receptacle of claim 1 wherein the first and second wall panels are formed from a pliable, resiliently compressible material.

14. The frozen treat receptacle of claim 13 wherein the first and second wall panels are formed from a resiliently compressible foam material.

15. The frozen treat receptacle of claim 14 wherein the first and second wall panels are formed from a closed cell foam material.

16. The frozen treat receptacle of claim 14 wherein the first and second wall panels have a thickness of approximately 2 mm.

17. The frozen treat receptacle of claim 1 further comprising a means for removably and replaceably coupling the frozen treat receptacle to an external structure.

18. The frozen treat receptacle of claim 17 wherein the means for removably and replaceably coupling the frozen treat receptacle to the external structure comprises a portion of hook material in combination with a portion of loop material.

19. The frozen treat receptacle of claim 17 wherein the means for removably and replaceably coupling the frozen treat receptacle to the external structure comprises a snap coupling.

20. A method for retaining a frozen confection, the method comprising the steps of:
providing a frozen treat receptacle wherein the frozen treat receptacle comprises a first wall panel and a second wall panel coupled to the first wall panel wherein the first wall panel is coupled to the second wall panel to define a pocket with an open mouth and an open inner volume for receiving at least a portion of a frozen confection and wherein the first wall panel and the second wall panel are formed from insulative material;
providing a frozen confection comprising an elongate bar of frozen liquid that retained within an elongate, generally rectangular sleeve;
inserting at least a portion of the frozen confection through the open mouth of the pocket and into the open inner volume thereof;
whereby the frozen confection can be retained with the frozen treat receptacle interposed between the frozen confection and a hand of a user.

21. The method of claim 20 wherein the first and second wall panels have first end edges, joined second end edges opposite and generally parallel to the first end edge, joined first side edges, and joined second side edges opposite and generally parallel to the first side edges.

22. The method of claim 21 wherein the second end edges, the first side edges, and the second side edges of the first and second wall panels are joined by adhesive interposed therebetween.

23. The method of claim 21 wherein the second end edges, the first side edges, and the second side edges of the first and second wall panels are joined by heat sealing.

24. The method of claim 21 wherein the second end edges, the first side edges, and the second side edges of the first and second wall panels are joined by sewn stitches.

25. The method of claim 21 wherein the second end edges, the first side edges, and the second side edges of the first and second wall panels are joined by a unitary formation of the first and second wall panels whereby the second end, the first side, and the second side of the frozen treat receptacle are devoid of seams.

26. The method of claim 21 wherein the first and second wall panels are formed from a generally rectangular single panel of material folded substantially evenly whereby a fold forms the first side of the frozen treat receptacle, the second end of the frozen treat receptacle is formed by opposed edges of the single panel that project away from the fold, and the second side of the frozen treat receptacle is formed by opposed edges of the single panel generally parallel to the fold.

27. The method of claim 20 wherein each of the first and second wall panels is generally rectangular with a width between first and second side edges of between approximately 2 and approximately 3 inches and a length between first and second end edges of between approximately 4 and approximately 6 inches.

28. The method of claim 27 wherein each of the first and second wall panels has a width between first and second side edges of approximately 2 and ½ inches and a length between first and second end edges of approximately 4 and ¾ inches whereby the frozen treat receptacle is ideally suited for receiving and retaining at least a base portion of a frozen confection.

29. The method of claim 20 wherein the first and second wall panels are formed from a pliable, resiliently compressible material.

30. The method of claim 29 wherein the first and second wall panels are formed from a resiliently compressible foam material.

31. The method of claim 30 wherein the first and second wall panels are formed from a closed cell foam material.

32. The method of claim 30 wherein the first and second wall panels have a thickness of approximately 2 mm.

33. The method of claim 20 further comprising the step of providing a means for removably and replaceably coupling the frozen treat receptacle to an external structure.
